(19) United States
(12) Patent Application Publication
(10) Pub. No.: US 2009/0175163 A1
(43) Pub. Date: Jul. 9, 2009

(54) METHOD AND APPARATUS OF PERFORMING PACKET DATA CONVERGENCE PROTOCOL RE-ESTABLISHMENT

(75) Inventors: Mohammed Sammour, Montreal (CA); Stephen E. Terry, Northport, NY (US); Shankar Somasundaram, Deer Park, NY (US); Rajat P. Mukherjee, Stanford, CA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/340,033

(22) Filed: Dec. 19, 2008

Related U.S. Application Data
(60) Provisional application No. 61/019,058, filed on Jan. 4, 2008.

(51) Int. Cl. H04L 1/00

(52) U.S. Cl. 370/216

(57) ABSTRACT

A method and apparatus of performing packet data convergence protocol (PDCP) re-establishment includes determining a PDCP re-establishment trigger. An error event is detected based upon the PDCP re-establishment trigger, and PDCP re-establishment procedures are requested.

### CROSS REFERENCE TO RELATED APPLICATIONS

This application claims the benefit of U.S. Provisional Application No. 61/019,058 filed Jan. 4, 2008, which is incorporated by reference as if fully set forth.

### FIELD OF INVENTION

The present invention is related to wireless communications.

### BACKGROUND

Current efforts for the Third Generation Partnership Project (3GPP) Long Term Evolution (LTE) program are directed toward developing new technology and new architectures for new methods and configurations. This effort is directed to provide improved spectral efficiency, reduced latency and better utilization of radio resources for faster user experiences and richer applications and services with less associated cost.

As part of these efforts, 3GPP is defining new procedures for the conventional radio resource control (RRC) and packet data convergence protocol (PDCP) layers to help meet these goals. One of the procedures that may be needed is a way to perform a PDCP reset, or re-establishment, which may be performed thorough the use of new PDCP control protocol data units (PDUs).

However, it may be also desirable to reset or re-establish a PDCP entity via RRC signaling, which may result in a less complex implementation. Currently no procedures or signaling exist to enable this. Accordingly, it would be beneficial to provide a method and apparatus of performing PDCP re-establishment.

### SUMMARY

A method and apparatus of performing packet data convergence protocol (PDCP) re-establishment is disclosed. The method includes determining a PDCP re-establishment trigger. An error event is detected based upon the PDCP re-establishment trigger, and PDCP re-establishment procedures are requested.

### BRIEF DESCRIPTION OF THE DRAWING

A more detailed understanding of the invention may be had from the following description of a preferred embodiment, given by way of example and to be understood in conjunction with the accompanying drawing wherein:

FIG. 1 shows an example wireless communication system including a plurality of wireless transmit/receive units (WTRUs) and an evolved Node-B (eNB);

FIG. 2A shows an example functional block diagram of a transmitter;

FIG. 2B shows an example functional block diagram of a receiver;

FIG. 3 is a flow diagram of an example method for performing a PDCP re-establishment; and

FIG. 4 shows an example signal diagram of a method for signaling a PDCP re-establishment.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, an eNB, a site controller, an access point (AP), or any other type of interfacing device capable of operating in a wireless environment.

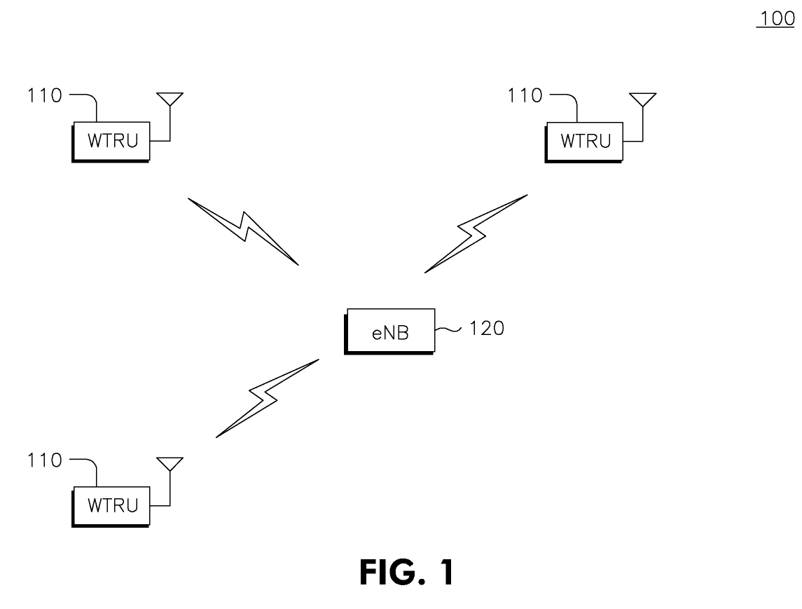

FIG. 1 shows an example wireless communication system 100 including a plurality of WTRUs 110 and an eNB 120. As shown in FIG. 1, the WTRUs 110 are in communication with the eNB 120. It should be noted that, although an example configuration of WTRUs 110 and an eNB 120 is depicted in FIG. 1, any combination of wireless and wired devices may be included in the wireless communication system 100.

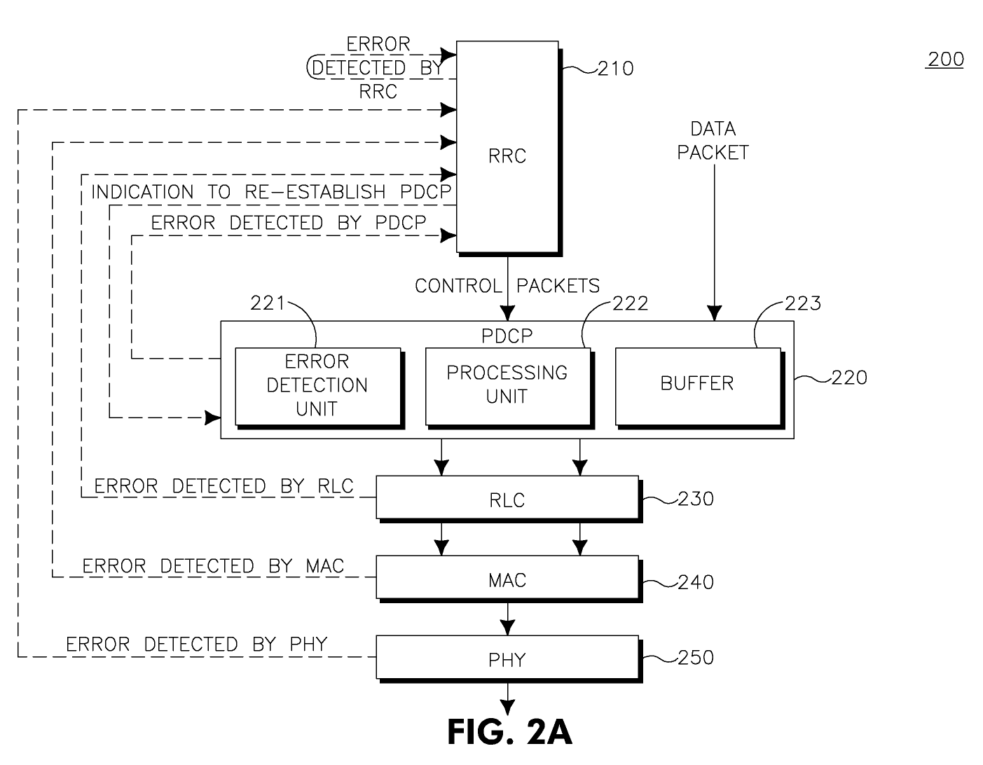

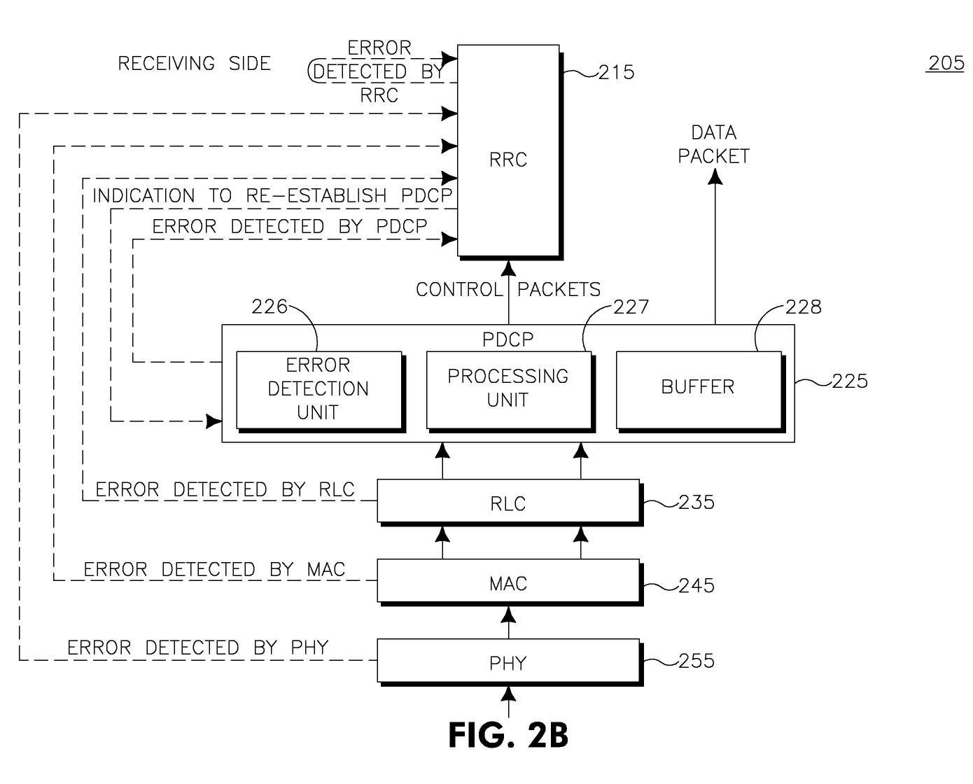

FIG. 2A shows a transmitter 200, which may be incorporated into the WTRU 110 or eNB 120. The transmitter includes an RRC layer/entity 210, a PDCP layer/entity 220, a radio link controller (RLC) layer/entity 230, a medium access control (MAC) layer/entity 240 and a physical (PHY) layer/entity 250. The PDCP layer/entity 220 may include an error detection unit 221, a processing unit 222 and a buffer 223.

As shown in FIG. 2A, when any of the PDCP 220, RLC 230, MAC 240 or PHY 250 layers/entities detect an error, the layer/entity that detects the error sends an indication to the RRC layer/entity 210 regarding the detected error. The RRC layer/entity 210 subsequently sends an indication to the PDCP layer/entity 220 requesting PDCP re-establishment. Additionally, when the RRC 210 internally detects an error, it may subsequently send an indication to the PDCP layer/entity 220 requesting PDCP reestablishment.

FIG. 2B shows a receiver 205, which may be incorporated into the WTRU 110 or eNB 120. The receiver 205 includes an RRC layer/entity 215, a PDCP layer/entity 225, an RLC layer/entity 235, a MAC layer/entity 245 and a PHY layer/entity 255. The PDCP layer/entity 225 may include an error detection unit 226, a processing unit 227 and a buffer 228.

As shown in FIG. 2B, when any of the PDCP 225, RLC 235, MAC 245 or PHY 255 layers/entities detect an error, the layer/entity that detects the error sends an indication to the RRC layer/entity 215 regarding the detected error. The RRC layer/entity 215 subsequently sends an indication to the PDCP layer/entity 225 requesting PDCP re-establishment. Additionally, when the RRC 215 internally detects an error, it may subsequently send an indication to the PDCP 225 layer/entity requesting PDCP reestablishment.

In addition, a non-access stratum (NAS) layer (not shown) may be present above the RRC layer/entity 210 in the transmitter 200 or RRC layer/entity 215 in the receiver 205.

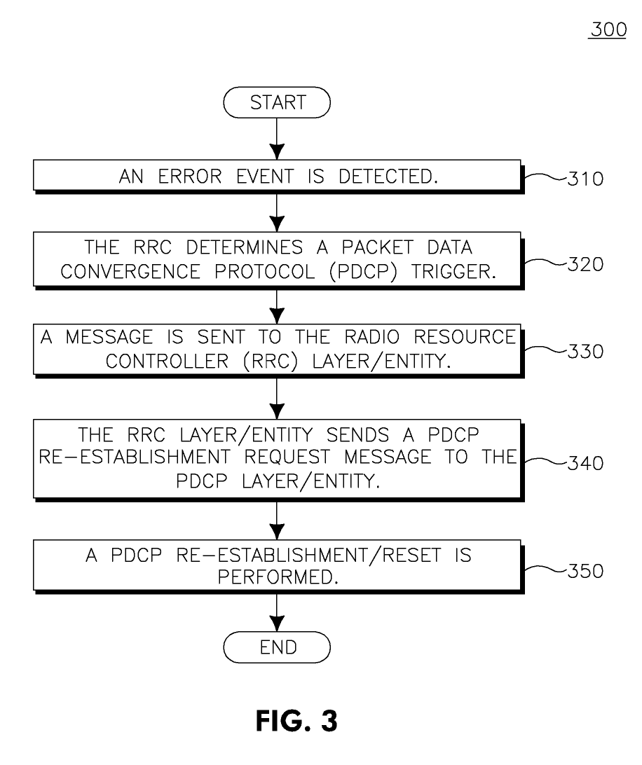

FIG. 3 is a flow diagram of an example method for performing a PDCP re-establishment 300. In step 310, an error event is detected. As described above, the error event may be detected by any of the PDCP 220, RLC 230, MAC 240 or PHY 250 layers/entities above. In one example, the PHY 250 may identify loss of synchronization or channel quality below a threshold to the RRC 210 which may then declare a radio link failure which may then cause the PDCP 220 reestablishment. Similarly the RLC 230 may report an error, such as the maximum number of retransmissions of an AMD PDU is reached, to the RRC 210 which may then instruct the PDCP 220 to re-establish.

Once the error event is reported from the PHY 250, MAC 240, or PDCP 220, the RRC layer/entity 210 determines a PDCP re-establishment trigger (step 320). This may also be referred to as a PDCP re-configuration. The triggers that cause a reset/re-establishment of the PDCP, (e.g., by the RRC), may include, but is not limited by any of the following triggers, (and for purposes of example, the layer where the triggering criteria may occur are shown in parenthesis):
An unrecoverable PDCP operation error, such as a buffer error (PDCP layer/entity 220).
A timeout of an expected PDCP-STATUS message acknowledgement (PDCP layer/entity 220).
A PDCP security unrecoverable error detected by either the transmitter 200 or the receiver 205 (PDCP layer/entity 220).
Integrity protection on the control-plane (C-plane), (e.g. integrity protection failure) (PDCP layer/entity 220).
Header decompression on the user-plane (U-plane) (PDCP layer/entity 220).
Resetting/re-establishing de-synchronized security parameters between peers (PDCP layer/entity 220 or RRC layer/entity 210 signaling).
A handover event or failure for LTE (PHY layer/entity 250).
Non-lossless radio bearer criteria, such as the maximum number of AMD PDU transmissions has been exceeded (RLC layer/entity 230).
PDCP Status PDUs indicating erroneous sequence numbers (PDCP layer/entity 220).
An error in a handover procedure (RRC layer/entity 210).
An error in a subsequent handover procedure where a subsequent handover is performed before completion of the first handover (RRC layer/entity 210).
An unrecoverable error in the header compression function and operation (PDCP layer/entity 220).
A lower layer indication from the RLC layer/entity 230, MAC layer/entity 240, and/or PHY layer/entity 250, requiring a corresponding PDCP layer/entity reset.

Additionally or alternatively, an upper layer intervention or command, trigger from the NAS on the U-plane may require a corresponding PDCP entity reset.

Once the error event is determined by the PHY 250, MAC 240, RLC 230, or PDCP 220 and met (step 310), either the PHY 250, MAC 240, RLC 230 or PDCP layer/entity 220 of the transmitter 200 sends an indication to the RRC layer/entity 210 (step 330). The indication may include information such as a cause value indicating the reason for the request,

In another embodiment, when an indication is generated from the PDCP layer/entity 220, status information indicating the last sequence number (SN) correctly received, and an identification of the PDCP entity to be reset/re-established may be included. In one example, the PDCP entity to be reset may be identified by the radio bearer associated with the PDCP entity or by the COUNT values used in ciphering for that entity. Alternatively, an identifier (ID) that explicitly identifies the PDCP entity may be indicated. In addition, the PDCP layer/entity 220 may generate a PDCP status PDU along with the reset/re-establishment.

Once the indicator from PHY, MAC, RLC or PDCP is sent to the RRC entity 210 (step 330), the RRC may request the PDCP layer/entity 220 to perform PDCP reset/re-establishment procedures (step 340). Also, a PDCP reset/re-establishment may be performed (step 350).

In step 320, for example, the entity sending the indication may suspend operation when the triggering criteria of the RRC indication is met or upon RRC request following reception of the lower layer error indication.

Transmission of any PDUs on the entity for which the error triggering criteria was met or for which entity the RRC requested reset/reestablishment may be suspended. In addition, reception of any PDUs received may also be discarded.

Also, the entity being reset or re-established may start a timer, (e.g. a T101 timer), and may also be reset to initial configured parameters, which may also take place after the expiration of the T101 timer. The procedures performed after the initial RRC reset/reestablishment request to PHY, MAC, RLC or PDCP may be performed after waiting for an subsequent indication from the RRC layer/entity 210, which may be in the form of an acknowledgement (ACK) of the reset request or a confirmation of the reset procedures being initiated by the RRC layer/entity 210.

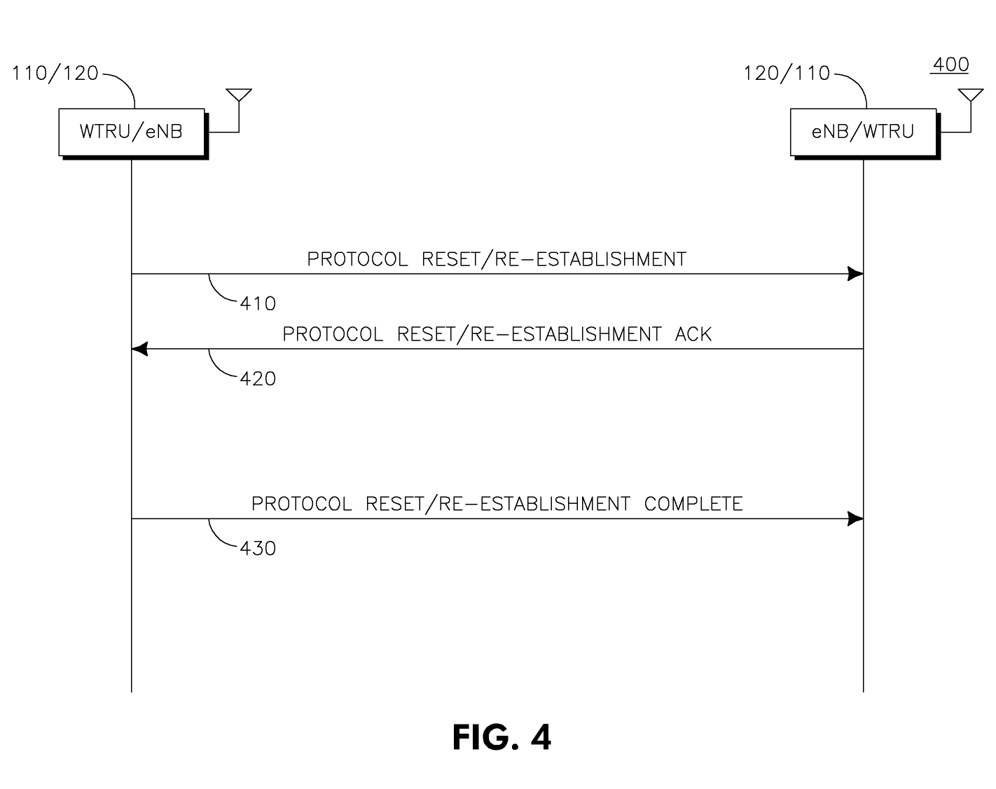

It may also be the case where the entity being re-established signals its peer entity in another device. For example, the WTRU 110 may signal the eNB 120, or vice versa. Accordingly, FIG. 4 shows an example signal diagram 400 of a method for signaling a PDCP re-establishment. For purposes of example, the transmitter 200, whether incorporated into the WTRU 110 or eNB 120 may be considered as the device that transmits PDCP protocol reset/re-establishment messages. The receiver 205, whether incorporated into the WTRU 110 or eNB 120 may be considered as the device that receives PDCP protocol reset/re-establishment messages.

In one example, once the RRC layer/entity 210 of the transmitter 200 receives the reset request from the PHY 250, MAC 240, RLC 230 or PDCP layer/entity 220, it may transmit a RRC protocol reset/re-establishment message to its peer entity in the receiver 205, (i.e., RRC layer/entity 215). The protocol reset/re-establishment message (410) may include a number of parameters that are required for the reset/re-establishment. These parameters may also be included in any RRC message, such as an RRC connection reconfiguration message.

One way of indicating the reset of a PDCP entity may be accomplished by utilizing a protocol reset indicator information element (IE) that is included in the RRC message or the protocol reset/re-establishment message (330). The IE may also be referred to as a PDCP reset IE. Table 1 below shows an example configuration of a protocol reset indicator IE.

TABLE 1

| | | | Type and | | |
|---|---|---|---|---|---|
| Information | Need | Multi | Reference | Semantics | Version |
| Information | | <1toNumberof | | | |
| for protocol | | entities | | | |
| entity for | | requesting | | | |
| reset | | Reset> | | | |
| > Protocol | | | Boolean | Identifies whether the entity | |
| entity | | | | being reset is a PDCP entity or | |
| requesting | | | | an RLC entity. This may not be | |
| reset | | | | necessary if the reset indicator | |
| | | | | IE is defined specifically for RLC | |
| | | | | or PDCP. | |
| >> Identity | | | Integer | Identification of the PDCP entity | |
| | | | | being reset. This may be RB ID | |
| | | | | mapped to the entity or some | |
| | | | | other ID. This information may | |
| | | | | be implied by the presence of | |
| | | | | some other information in a | |
| | | | | parent field in the information | |
| | | | | tree. | |
| >>> RSN | | | Integer | The Reset SN identifies if this is | |
| | | | | the first reset request for this | |
| | | | | entity or a retransmission. | |
| | | | | Alternatively the RSN may be | |
| | | | | defined for the entire RRC | |
| | | | | message instead of on a per- | |
| | | | | entity basis | |
| >>> Cause | | | Integer | Indicates the reason for reset | |
| | | | | request | |
| >>> Reset | | | Boolean | Identifies if the PDCP entity is | |
| configuration | | | | to be reset to default/initial | |
| | | | | configurations or some different | |
| | | | | configuration | |
| >>>> | | | | If PDCP entity is to be reset to a | |
| Parameters | | | | configuration different from | |
| for reset | | | | initial/default. | |

The IEs described above in Table 1 are exemplary and it should be noted that the information contained in them may be transmitted in other ways. For example, the RRC signal indicating the reset may be a bit or several bits included in any RRC message, or in a dedicated message. In addition, the indication may be implicit. The status of the RLC or PDCP may also be included. For example, by receiving a specific message, such as a handover message, it can be implied or understood that PDCP re-establishment should be part of the actions to be performed upon receiving such a message.

Other information that the protocol reset/re-establishment message (410) may include is an explicit or implicit indication of the time of the reset, or activation, of reset. This may also be performed on a transmission time interval (TTI), or system frame number (SFN) basis. For example, the synchronization between the RRC procedure and the PDCP reset/re-establishment may be aligned with the SFN or a number of TTIs relative to the last TTI in which the RRC message was transmitted and received. Additionally it may be based on COUNT/SN values.

If the PDCP entity to be reset/re-established is the same PDCP entity that transmits the RRC message indicating the reset/re-establishment, the RRC layer/entity 210 may transmit the message (410) indicating the reset over a radio bearer mapped to a different PDCP entity, or configure a radio bearer and associated PDCP entity to transmit the message.

The RRC message (410) containing the PDCP reset/re-establishment indication may also be transmitted on a signaling radio bearer (SRB). In addition to the reset/re-establishment of PDCP, the SRB may be utilized for other purposes, such as the resetting of the RLC. The SRB may also be mapped to an RLC unacknowledged mode (UM) entity to avoid the possibility of the SRB being reset.

The RRC layer/entity 210 may also perform additional functions, such as ensuring that the protocol reset/re-establishment message (410) can be contained within a single RLC PDU, and aggregating multiple reset/re-establishment requests from various PDCP entities, or entities in different protocol layers, (e.g., PDCP, RLC, MAC, and the like), into a single message. In addition, the RRC layer/entity 210 may ignore reset requests from a PDCP layer/entity for which a reset/re-establishment is ongoing.

The RRC layer/entity 210 may choose to ACK the reset/re-establishment request from the transmitting PDCP layer/entity, and may indicate that a PDCP reset/re-establishment is pending to the RLC. An RLC status PDU may thereby be triggered upon receipt of this indication.

Once the protocol reset/re-establishment message (410) is transmitted, the RRC layer/entity 210 may perform additional functions. For example, the RRC layer/entity 210 may start a timer, (e.g., T102) that may determine the time the transmitting RRC layer/entity 210 waits for an acknowledgement before initiating further action. In addition, the RRC layer/entity 210 may increment or decrement a counter, (e.g., C102), that keeps a count of the number of reset requests. This counter may be specific to each PDCP entity and may be used to indicate the Reset SN (RSN) for the reset request. Furthermore, the RRC layer/entity 210 may provide an indication to the PDCP layer/entity 220 that the reset/re-establishment procedure has been initiated.

Moreover, when the T102 expires the RRC layer/entity 210 may retransmit the reset/re-establishment request, send a new reset request, increment or decrement the C102 counter and restart the timer T102. The RRC layer/entity 210 may provide an indication to the PDCP layer/entity 220 at the onset of one of these events, as well.

Regarding the counter (C102), if the counter reaches a pre-determined value, such as a value for a maximum number of reset requests, the RRC layer/entity 210 may initiate an alternate set of procedures. For example, the RRC layer/entity 210 may utilize RRC reconfiguration procedures, radio link failure procedures, physical channel reconfiguration procedures, an RLC reset procedure, and the like.

In order to distinguish between retransmissions of the protocol reset/re-establishment message (410), the RRC layer/entity 210 may utilize an RRC transaction identifier. Additionally, HARQ assistance may be utilized to retransmit the RRC message that contains the reset indicator. For example, a HARQ entity (not shown) may indicate to the RRC layer/entity 210 that delivery of the RRC PDU that contains the PDCP reset has failed, and hence the RRC entity retransmits the PDU.

Once the receiver 205 receives the protocol reset/re-establishment message 410, the RRC layer/entity 215 in the receiver may perform a number of functions. For example, RRC layer/entity 215 in the receiver 205 may transmit a protocol reset/re-establishment ACK message (420) back to the transmitter 200. The RRC layer/entity 210 may also forward the reset/re-establishment message on to the PDCP layer/entity 225 in the receiver 205 and not transmit the ACK message (420) until receiving a confirmation from the PDCP layer/entity 225.

In addition, the RRC layer/entity 215 may stop transmission or reception of any PDUs on the radio bearers configured for that PDCP entity, flush the data buffer, and/or forward the reset/re-establishment request, along with any reset parameters, on to the RLC layer/entity 235 or PDCP layer/entity 225.

In the event that the PDCP entity to be reset is the same PDCP entity that would transmit the RRC message indicating the reset acknowledgement, the RRC layer/entity 215 may transmit the protocol reset/re-establishment ACK message (420) over a radio bearer mapped to a different PDCP entity, or via a newly configured radio bearer and associated PDCP entity. The RRC message containing the PDCP reset ACK indication may also be transmitted on an SRB that may be dedicated to the reset acknowledgement of the PDCP and/or other purposes, (e.g., reset acknowledgement of an RLC reset request). In addition, this SRB may be mapped to an RLC UM entity to avoid the possibility of this SRB being reset.

The RRC layer/entity 215 may also perform additional functions, such as ensuring that the protocol reset/re-establishment ACK message (420) can be contained within a single RLC PDU, and aggregating multiple reset/re-establishment requests from various PDCP entities, or entities in different protocol layers, (e.g., PDCP, RLC, MAC, and the like), into a single message.

In addition, the RRC layer/entity 215 may utilize HARQ assistance to retransmit the RRC message (420) that contains the reset acknowledgment indicator. For example, a HARQ entity (not shown) may indicate to the RRC layer/entity 215 that delivery of the RRC PDU that contains the PDCP reset acknowledgment has failed. The RRC layer/entity 215 may then retransmit the PDU.

One way to provide the acknowledgement may be through the use of a protocol reset ACK IE, which may also be known as a PDCP reset ACK IE, that could be contained in an RRC message, or in a message dedicated to reset procedures. Table 2 below shows an example configuration of a protocol reset ACK IE.

TABLE 2

| | | | Type and | | |
|---|---|---|---|---|---|
| Information | Need | Multi | Reference | Semantics | Version |
| Information for | | <1toNumberof | | | |
| protocol entity | | entities for Reset | | | |
| reset being | | being acked> | | | |
| acknowledged | | | | | |
| > Protocol entity | | | Boolean | Identifies whether the | |
| for reset being | | | | entity being reset acked is | |
| acknowledged | | | | a PDCP entity or an RLC | |
| | | | | entity. This may not be | |
| | | | | necessary if the reset ack | |
| | | | | indicator IE is defined | |
| | | | | specifically for RLC or | |
| | | | | PDCP. | |
| >> Identity | | | Integer | Identification of the PDCP | |
| | | | | entity being reset acked. | |
| | | | | This may be the RB ID | |
| | | | | mapped to the entity or | |
| | | | | some other ID. This | |
| | | | | information may be implied | |
| | | | | by the presence of some | |
| | | | | other information in a | |
| | | | | parent field in the | |
| | | | | information tree. | |
| >>> RSN | | | Integer | The Reset SN identifies the | |
| | | | | corresponding reset request | |
| | | | | that is being acked. This | |
| | | | | shall be the same as the | |
| | | | | RSN in the corresponding | |
| | | | | reset request. | |

It should be noted that the IEs described in Table 2 above may be signaled in alternate manners.

In addition to transmitting an ACK message, (i.e., message 420), PDCP reset/re-establishment procedures may be performed at the receiver 205. For example, the PDCP layer/entity 225 at the receiver 205 may perform any combination of the following procedures, which may be performed even if the PDCP reset procedure is achieved via PDCP reset PDUs, (i.e., the procedure is supported in the PDCP layer/entity 225 itself), instead of via the RRC.

When the PDCP layer/entity 225 is reestablished, it may generate a PDCP status PDU. It may also reset some or all of the PDCP state variables for that entity to the initial or default values, or to the value configured in the reset request if a value was configured. As an example, header compression and operation states may be reset to the initial state and a full header, (e.g., Internet protocol (IP)/transmission control protocol (TCP), or IP/user datagram protocol (UDP)/real time protocol (RTP)), may be transmitted and received after the reset, as per the header compression algorithm.

PDCP reordering, in-sequence-delivery, or duplication detection operations and its parameters may be reset, as well as resetting configurable parameters to their initial or configured values. If any new values are received in the reset request, those values may be configured.

Stopping or restarting timers associated with the PDCP entity may be performed. Additionally, SDU and/or PDU buffers may be flushed. Alternatively, in the transmitting PDCP entity, the PDCP SDUs may not be flushed but instead, new PDCP PDUs may be built and SNs may be re-assigned after the reset. This PDCP SDU processing procedure may be applied to all PDCP SDUs for which the discard timer has not yet expired or for SDUs that delivery has not been confirmed. If the PDCP SDUs are kept in the buffer 228 during a PDCP reset, the discard timer, or timers, associated with the SDUs may be maintained, (i.e., not re-initialized) and may continue after the PDCP reset. That is, the discard timers associated with PDCP SDUs are not affected by the PDCP reset if the SDUs are not.

In the receiving PDCP layer/entity 225, any SDUs that are stored in the PDCP reordering buffer may be delivered to an upper layer. This may be useful if a reset happens while the PDCP reordering function is active, such as due to a handover.

The completion of the reset procedures may be confirmed by the PDCP layer/entity 225 to the RRC layer/entity 215, as well as the completion of the reset may be indicated to lower layers, such as the RLC layer/entity 235.

In addition, the PDCP reset may be synchronized with the RRC procedure, and the RRC procedure may include an explicit or implicit indication of the time of the reset/re-establishment and/or activation of the reset/re-establishment. The synchronization may also be accomplished on a TTI or SFN basis. For example, the synchronization between the RRC procedure and the PDCP reset/re-establishment may be aligned with the SFN or a number of TTIs relative to the last TTI in which the RRC message was transmitted and received.

Once the transmitter 200 receives the protocol reset/re-establishment message (420), the RRC layer/entity 210 and the PDCP layer/entity 220 may perform procedures, respectively. For example, the RRC layer/entity 210 may stop a T102 timer, reset the counter C102 to its initial value or zero, and/or confirm the acknowledgement to the RLC layer/entity 230 and the PDCP layer/entity 220.

Upon receiving acknowledgement of the reset request via the RRC layer/entity 210, the PDCP layer/entity 220 at the transmitter 200 may perform one or more functions as follows. For example, the PDCP layer/entity 220 may stop the T101 timer, reset the C101 counter to zero, or generate a PDCP status PDU.

In addition, the PDCP layer/entity 220 may reset some or all of the PDCP state variables for itself to their initial/default values or to a value configured in the reset request, if one was configured. As an example, header compression and operation states are reset to the initial state and a full header (IP/TCP or IP/UDP/RTP) may be transmitted and received after the reset per the header compression algorithm.

PDCP reordering, in-sequence-delivery or duplication detection operations and its parameters may be reset. In addition, configurable parameters may be reset to their configured values or to a new value, if one is received in the reset request. Stopping and/or restart any or all timers associated with that that entity may be performed, as well as flushing of SDU and/or PDU buffers.

Alternatively, in the transmitting PDCP entity, PDCP SDUs to be transmitted may not be flushed but SNs may be re-assigned instead after the reset. If the PDCP SDUs are kept in the buffer 220 during a PDCP reset, the discard timer, or timers, associated with the SDUs are maintained, (i.e., not re-initialized), and continue after the PDCP reset. That is, the discard timers are not affected by the PDCP reset if the SDUs are not affected. The transmitter 200, once PDCP re-establishment is completed, may also send a PDCP reset/re-establishment complete message (430) to the receiver 205.

In the receiving PDCP entity, any SDUs that are stored in the PDCP reordering buffer may be delivered to an upper layer. This may be useful if a reset happens while the PDCP reordering function is active, such as due to handover. Completion of the reset procedures may be confirmed to the RRC layer/entity 210, and completion of the reset may be indicated to lower layers, such as the RLC layer/entity 230. The RLC layer/entity 230 may then utilize the indication of a PDCP reset, whether received from the RRC layer/entity 210 or the PDCP layer/entity 220, to generate an RLC status PDU.

Some of the actions described above may be used or applied even when the PDCP reset procedure is achieved via PDCP reset PDUs, (i.e., via supporting the PDCP reset procedure in the PDCP layer itself), as opposed to supporting PDCP reset via the RRC.

In addition, the PDCP reset/re-establishment may be synchronized with the RRC procedure, and the RRC procedure may include an explicit or implicit indication of the time of the reset/activation of reset. Alternatively, this may be accomplished on a TTI or SFN basis. For example, the synchronization between the RRC procedure and the PDCP reset/re-establishment may be aligned with the SFN or a number of TTIs relative to the last TTI in which the RRC message was transmitted and received.

An embodiment for PDCP reset accomplished via RRC is described. A new procedure in the RRC entitled “Protocol Reset” may be used for resetting sub-layers, (e.g., RLC, PDCP). Alternatively, the elementary procedure may be specifically for RLC and/or PDCP, (e.g., “RLC Reset” and “PDCP Reset”). Alternatively, the procedure may be accomplished via carrying the proposed information via other procedures' messages, such as the messages used by the “RRC connection reconfiguration” procedure, those used by the “RRC connection re-establishment” procedure, or by any other RRC procedure.

The reset/re-establishment procedure for the PDCP implemented by RRC signaling and the triggers for the initiation and execution described above may be applicable to all wireless devices and systems. An example of such wireless systems are those related to 3GPP LTE and/or high speed packet access (HSPA) enhancements, such as the wideband code division multiple access (WCDMA) evolution, releases seven and eight (R7, R8) and the like.

Although the features and elements are described in particular combinations, each feature or element can be used alone without the other features and elements or in various combinations with or without other features and elements. The methods or flow charts provided may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method of performing packet data convergence protocol (PDCP) re-establishment, comprising:
determining a PDCP re-establishment trigger;
detecting an error event based upon the PDCP re-establishment trigger; and
requesting PDCP re-establishment procedures.

2. The method of claim 1 wherein a lower layer entity detects the error event, the lower level including any one of the following entities: a medium access control (MAC) entity, a physical layer (PHY) entity, a PDCP entity, and a radio link controller (RLC) entity.

3. The method of claim 1 wherein the re-establishment trigger includes detecting a PDCP security unrecoverable error.

4. The method of claim 1 wherein the re-establishment trigger includes a lower layer indication of a re-establishment.

5. The method of claim 4 wherein the re-establishment includes a detection of a radio link failure.

6. The method of claim 1, further comprising performing PDCP re-establishment procedures.

7. The method of claim 1, further comprising transmitting a protocol reset/re-establishment signal over the air upon the determination of a PDCP re-establishment.

8. The method of claim 7 wherein the protocol reset/re-establishment signal includes a protocol reset/re-establishment indicator information element (IE) in the protocol reset/re-establishment signal.

9. The method of claim 7, further comprising receiving a protocol reset/re-establishment acknowledgment signal.

10. The method of claim 9, further comprising transmitting a protocol reset/re-establishment complete signal in response to receiving the protocol reset/re-establishment acknowledgment signal and performance of the PDCP re-establishment procedures.

11. A wireless transmit/receive unit (WTRU), comprising:
a packet data convergence protocol (PDCP) entity; and
a radio resource controller (RRC) entity; and
wherein the RRC entity is configured to determine a PDCP re-establishment trigger, receive an error message from a lower layer entity indicating a detected error event based upon the PDCP re-establishment trigger, and send a PDCP re-establishment request to the PDCP entity, and wherein the PDCP entity is configured to perform a PDCP re-establishment.

12. The WTRU of claim 11 wherein the PDCP entity includes an error detection unit, a processing unit, and a buffer.

13. The WTRU of claim 12 wherein the error detection unit of the PDCP entity is configured to detect a PDCP error and transmit an error detection signal to the RRC entity.

14. The WTRU of claim 11 wherein the RRC entity is further configured to transmit a protocol reset/re-establishment signal.

15. The WTRU of claim 14 wherein the RRC entity is further configured to transmit a protocol reset/re-establishment complete signal.

16. The WTRU of claim 8 wherein the lower layer entity includes any one of the following entities: a radio link controller (RLC) entity, a medium access control (MAC) entity, a physical (PHY) entity, and the PDCP entity.

17. An evolved Node-B (eNB), comprising:
a packet data convergence protocol (PDCP) entity; and
a radio resource controller (RRC) entity; and
wherein the RRC entity is configured to receive a protocol reset/re-establishment signal and transmit a protocol reset/re-establishment acknowledgement (ACK).

18. The eNB of claim 17 wherein the PDCP entity further comprises an error detection unit, a processing unit, and a buffer.

19. The eNB of claim 17 wherein the RRC entity is further configured to receive a protocol reset/re-establishment complete signal.

20. The eNB of claim 18, further comprising:
a radio link controller (RLC) entity configured to detect an error and transmit an error detection indication to the RRC entity;
a medium access control (MAC) entity configured to detect an error and transmit an error detection indication to the RRC entity; and
a physical (PHY) entity.
